(19) United States
(12) Patent Application Publication
(10) Pub. No.: US 2017/0224134 A1
(43) Pub. Date: Aug. 10, 2017

(54) MONEY DEPOSITING/DISPENSING APPARATUS

(71) Applicant: TOSHIBA TEC KABUSHIKI KAISHA, Tokyo (JP)

(72) Inventors: Osamu WATANABE, Fuji Shizuoka (JP); Yuki Kawaguchi, Tagata Shizuoka (JP); Takeshi Haraguchi, Izunokuni Shizuoka (JP)

(21) Appl. No.: 15/421,639

(22) Filed: Feb. 1, 2017

(30) Foreign Application Priority Data
Feb. 5, 2016 (JP) 2016-020732

(51) Int. Cl. A47F 9/04; G07D 3/00; G07F 5/24; G07D 1/06

(52) U.S. Cl. CPC A47F 9/04; G07D 1/06; G07D 3/00; G07F 5/24; A47F 9/047

(57) ABSTRACT

A money depositing/dispensing apparatus comprises a coin depositing/dispensing device, configured to store coins acquired through a coin reception port, which includes a first path along which the stored coins travel to a coin dispensing port and a second path along which the stored coins travel to be saved, a bill depositing/dispensing device, configured to store bills acquired through a bill reception port and discharge the stored bills to a bill dispensing port, which is arranged at the lower side of the coin depositing/dispensing device in a space formed at the lower part of the coin dispensing port, and a container, configured to store coins traveling along the second path, which is detachably attached to the coin depositing/dispensing device in the space.

### CROSS-REFERENCE TO RELATED APPLICATION

This application is based upon and claims the benefit of priority from Japanese Patent Application No. 2016-020732, filed Feb. 5, 2016, the entire contents of which are incorporated herein by reference.

### FIELD

Embodiments described herein relate generally to a money depositing/dispensing apparatus.

### BACKGROUND

In recent years, a money depositing/dispensing apparatus, such as a self-checkout register (referred to as a self-checkout apparatus or a self-checkout POS (point-of-sale) terminal), is used. The self-checkout register is installed in a retail store such as a supermarket to carry out a registration processing and a settlement processing of purchased commodities by a customer himself/herself. The self-checkout register is equipped with a coin depositing/dispensing device and a bill depositing/dispensing device.

The coin depositing/dispensing device receives coins for payment, stores the coins in a storage section, and dispenses coins as change from the storage section. If coins overflow, in other words, if the amount of the available coins for being stored in the storage section reaches an upper limit, the conventional self-checkout register becomes inoperative, and a correctional work for dealing with such problem by a store clerk is required. The store clerk first opens a door of the self-checkout register, to attach a dedicated container such as a bag to the coin depositing/dispensing device, and collects coins stored in the storage section into the container. A customer cannot use the self-checkout register while the correctional work is carried out.

An unusable state caused by the overflow of coins as stated above can occur in any device for depositing/dispensing coins and is not limited to the self-checkout register.

### DESCRIPTION OF THE DRAWINGS

FIG. 1 is a front view illustrating the appearance of a self-checkout register according to an embodiment;

FIG. 2 is a perspective view illustrating the appearance of the self-checkout register when viewed obliquely from the top;

FIG. 3 is a perspective view illustrating the appearance of a first housing of which a door is opened;

FIG. 4 is a front view illustrating the appearance of a money depositing/dispensing section of a settlement terminal in a state in which a door is removed;

FIG. 5 is a perspective view illustrating the appearance of the money depositing/dispensing section of the settlement terminal in a state in which a door is removed;

FIG. 6 is a perspective view illustrating the appearance of a collection bag;

FIG. 7 is a front view illustrating a shape of the bag part in a state in which the bag part is simplified; and

FIG. 8 is a block diagram illustrating the hardware constitution of the self-checkout register.

### DETAILED DESCRIPTION

In accordance with an embodiment, a money depositing/dispensing apparatus comprises: a coin depositing/dispensing device, configured to store coins acquired through a coin reception port, which includes a first path along which the stored coins travel to a coin dispensing port and a second path along which the stored coins travel to be saved; a bill depositing/dispensing device, configured to store bills acquired through a bill reception port and discharge the stored bills to a bill dispensing port, which is arranged at the lower side of the coin depositing/dispensing device in a space formed at the lower part of the coin dispensing port; and a container, configured to store coins traveling along the second path, which is detachably attached to the coin depositing/dispensing device in the space.

Hereinafter, an embodiment of a money depositing/dispensing apparatus is described in detail with reference to the accompanying drawings. In the present embodiment, a self-checkout register (referred to as a self-checkout POS (Point Of Sales) terminal) is described as an example of the money depositing/dispensing apparatus. The self-checkout register is a terminal device for carrying out a commodity registration process and a settlement process of purchased commodities by a customer.

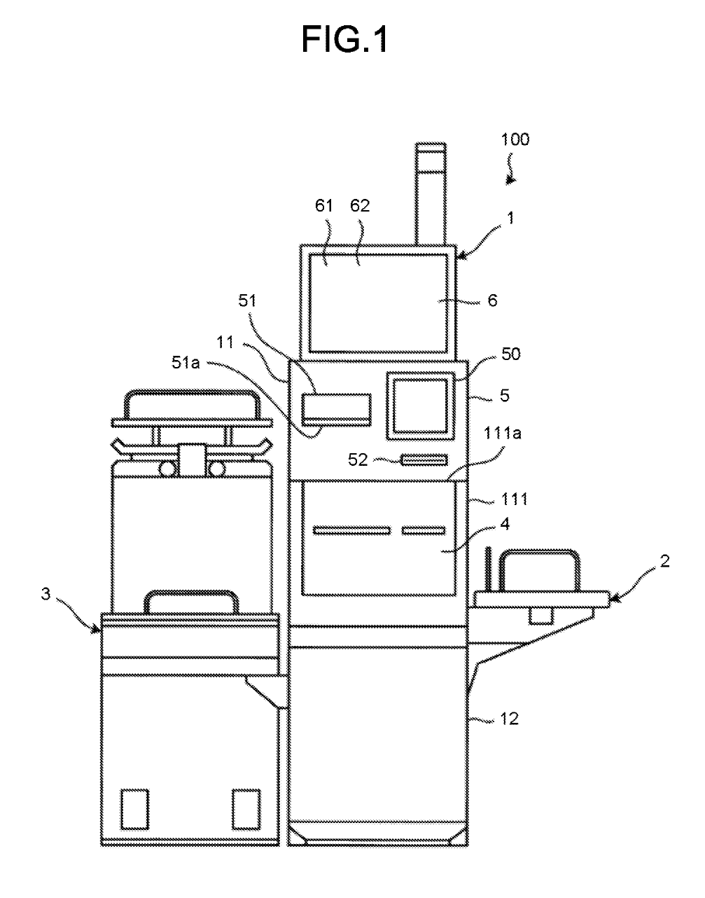

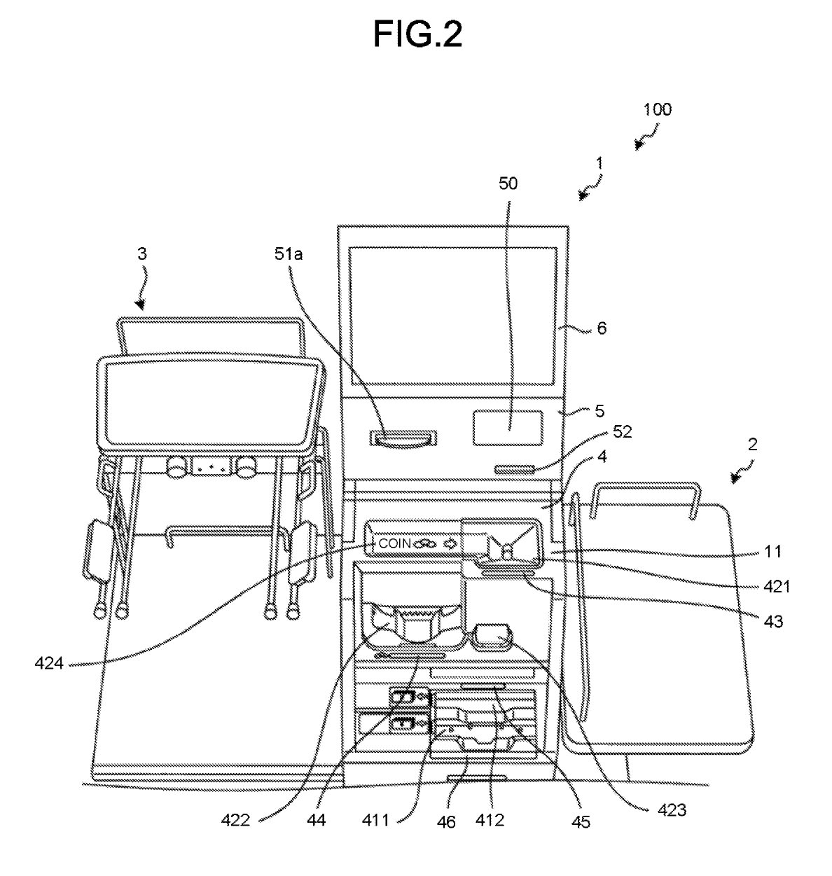

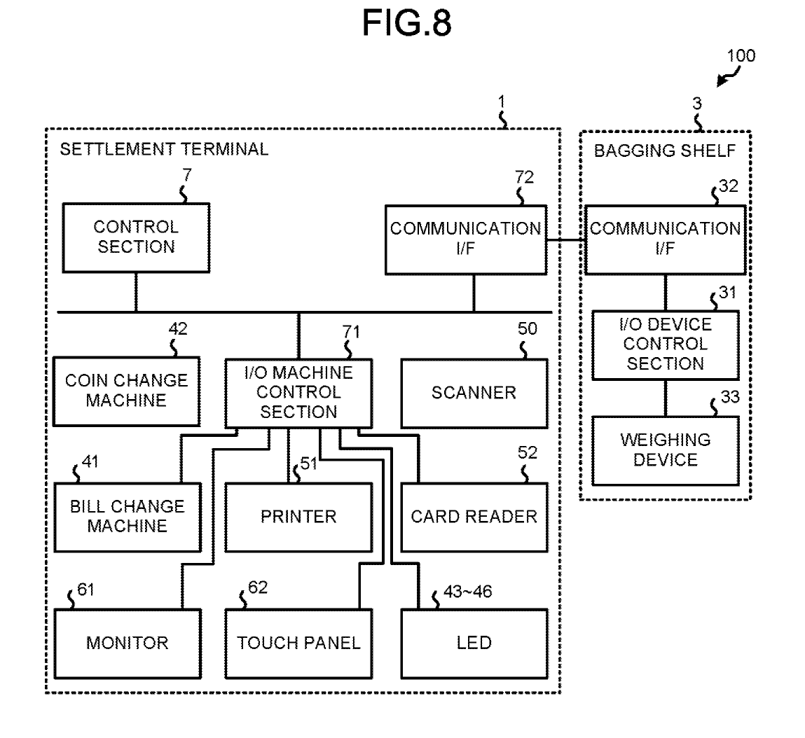

FIG. 1 is a front view illustrating the appearance of a self-checkout register 100 according to an embodiment. FIG. 2 is a perspective view illustrating the appearance of the self-checkout register 100 when viewed from above. The self-checkout register 100 (hereinafter referred to as a self-POS) is provided with a settlement terminal 1, a basket placing shelf 2 and a bagging shelf 3. The settlement terminal 1 is equipped with a money depositing/dispensing section 4, a reading section 5, a display and operation section 6, and a control section 7 (refer to FIG. 8) for controlling each section.

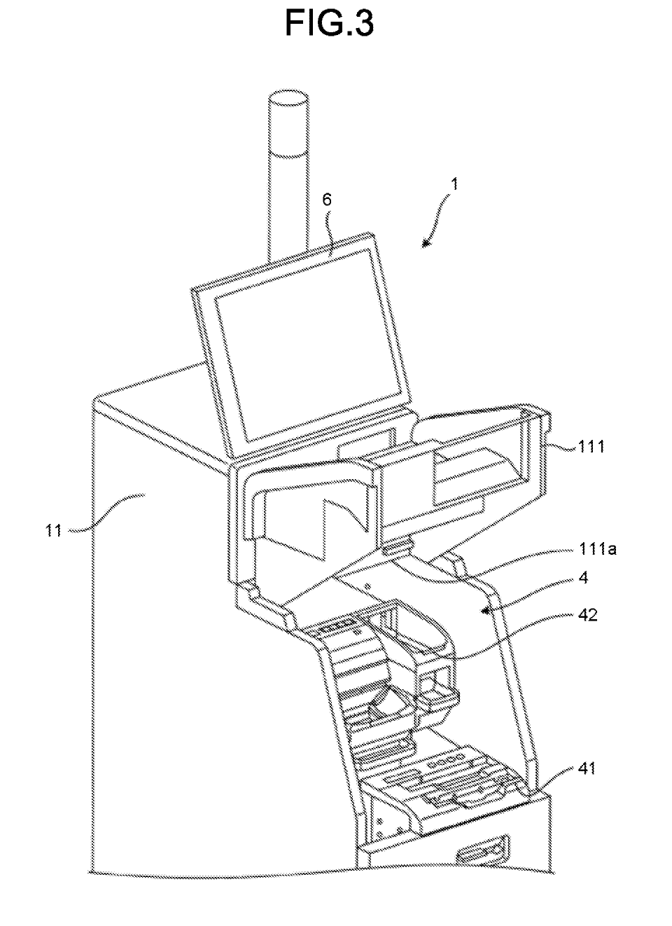

The settlement terminal 1 is provided with a first housing 11 and a second housing 12. The first housing 11 is provided with an openable and closable door 111. FIG. 3 is a perspective view illustrating the appearance of the first housing 11 of which the door 111 is opened. The door 111 rotates in the vertical direction around a hinge section 111a. The first housing 11 houses a money depositing/dispensing section 4. The money depositing/dispensing section 4 is composed of a bill change machine (bill depositing/dispensing device) 41 and a coin change machine (coin depositing/dispensing device) 42. The first housing 11 rotates the door 111 upwards to open the inside of the first housing 11 to expose the bill change machine 41 and the coin change machine 42. Returning to FIG. 1 and FIG. 2, the second housing 12 houses the control section 7 (shown in FIG. 8).

The reading section 5 is equipped with a scanner 50 for reading the appearance of a commodity and a symbol (barcode and the like) attached to the commodity to specify the commodity. Further, the reading section 5 is equipped with a printer 51 for printing a receipt according to a commodity sales data processing executed by the control section 7. The printer 51 includes a receipt discharge table 51a, which supports a discharged receipt, protruding from the first housing 11. The receipt discharge table 51a is a convex-shaped table protruding from the first housing 11. The reading section 5 is equipped with a card reader 52 for reading of a credit card in a settlement process executed by the control section 7.

The display and operation section 6 is provided with a monitor 61 and a touch panel 62. The monitor 61 displays an image according to instructions of the control section 7. The touch panel 62 is arranged on the surface of the monitor 61 to output information relating to a position on the panel 62 touched by an operator to the control section 7.

The basket placing shelf 2 is an article placing table on which a basket is placed at the time when shopping is completed. The basket placing shelf 2 facilitates an operation of the customer such as removing a commodity in the basket and holding the commodity over the reading section 5. The basket placing shelf 2 is arranged at one of the sides of the settlement terminal 1.

The bagging shelf 3 is a table for bagging the scanned commodity. The bagging shelf 3 is arranged at the other side of the settlement terminal 1 (at the opposite side of the basket placing shelf 2).

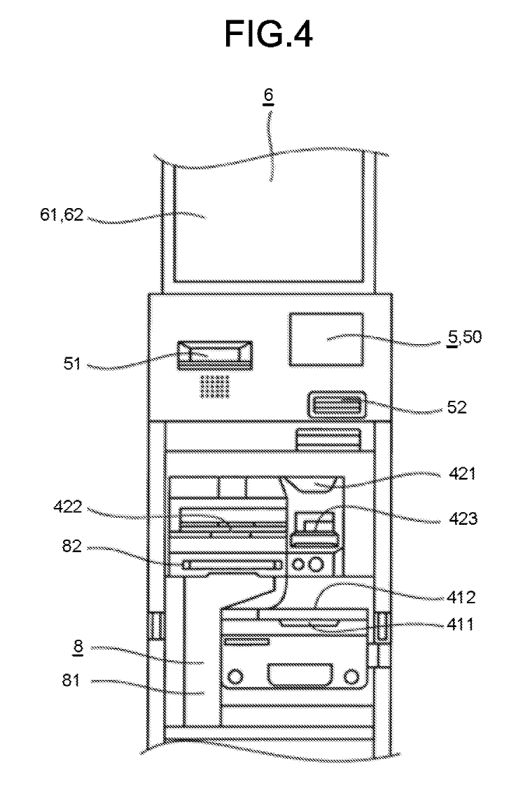

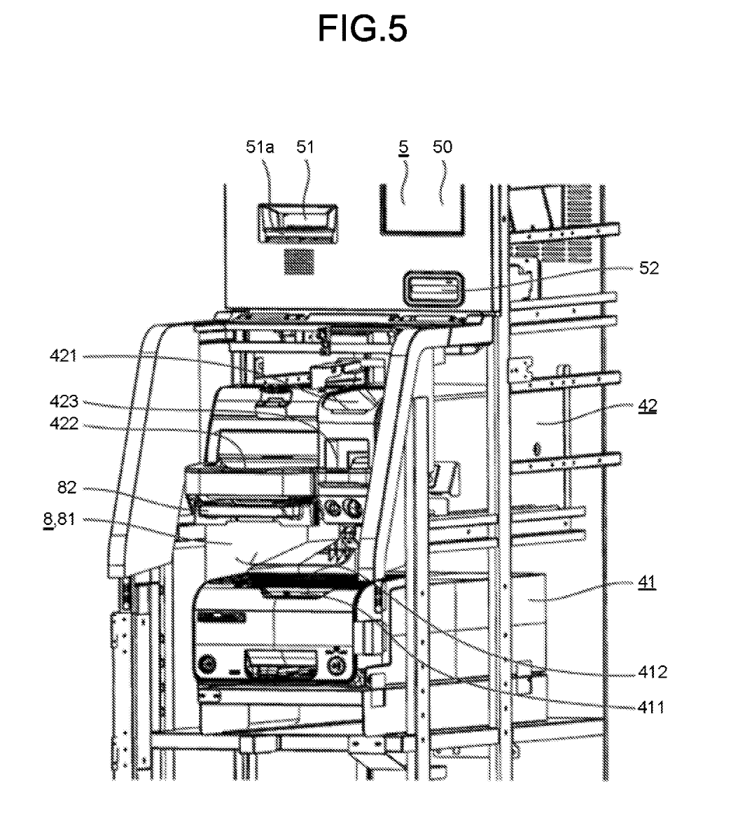

FIG. 4 is a front view illustrating the appearance of the money depositing/dispensing section 4 of the settlement terminal 1 in a state in which the door 111 is removed. FIG. 5 is a perspective view similarly illustrating the appearance of the money depositing/dispensing section 4 of the settlement terminal 1 in a state in which the door 111 is removed. The bill change machine 41 and the coin change machine 42 are housed in the first housing 11 in a stacking manner in a state in which the bill change machine 41 is located below the coin change machine 42.

The bill change machine 41 (shown in FIG. 3) determines an authenticity (true or false) of acquired bills to store them (only genuine bills) as specified, and dispenses bills as change. The coin change machine 42 determines true or false of acquired coins to store them as specified, and dispenses coins as change. The bill change machine 41 and the coin change machine 42 notify the control section 7 of the amount of the stored money. Further, the bill change machine 41 and the coin change machine 42 receive a notification of an amount to be dispensed as change from the control section 7.

The control section 7 collectively controls each section (the money depositing/dispensing section 4, the reading section 5, and the display and operation section 6) included in the settlement terminal 1. The control section 7 acquires code information from the reading section 5. The control section 7 outputs information to be displayed on the monitor 61 of the display and operation section 6 and acquires information of operations carried out by an operator through the touch panel 62. Further, the control section 7 controls the money depositing/dispensing section 4 to collect money deposited to the money depositing/dispensing section 4 and to dispense money from the money depositing/dispensing section 4.

As shown in FIG. 2, a depositing port (coin depositing port or coin reception port) 421 for coins to be deposited to the coin change machine 42 is arranged at one of the end sides of the upper part of the first housing 11 (near the basket placing shelf 2). In the first housing 11 (money depositing/dispensing section 4), a stage (surface) including a coin discharge dish (coin dispensing port) 422, a reject dish 423 and a stage including a bill depositing port (bill reception port) 411 and a bill discharge port (bill dispensing port) 412 are arranged in a stepwise manner in order from the back (far) side at which the coin depositing port 421 is arranged to the front (near) side. In other words, the coin depositing port 421 is arranged at the upper stage, the coin discharge dish 422 and the reject dish 423 are arranged at the middle stage, and the bill depositing port 411 and the bill discharge port 412 are arranged at the lower stage. In this manner, by arranging various kinds of depositing ports and discharge ports (discharge dishes) in a stepwise manner, all the depositing ports and the discharge ports (discharge dishes) can be seen from the back (far) side to the front (near) side.

The coin discharge dish 422 is a reception dish for receiving a coin discharged from the coin change machine 42. The reject dish 423 is a reception dish for receiving a coin (reject coin) such as a deformed coin, a foreign coin and/or a counterfeit coin which are not to be stored in the coin change machine 42. A positional relationship of the coin depositing port 421, the coin discharge dish 422 and the reject dish 423 depends on the structure of the coin change machine 42.

The coin depositing port 421 and the coin discharge dish 422 are arranged at positions separated along the width direction of the first housing 11. In this manner, the coin depositing port 421 and the coin discharge dish 422 are arranged apart from each other in the height direction, the width direction and the depth direction, and thus visibility and operability for the coin discharge dish 422 are increased. Furthermore, the reject dish 423 is arranged at the lower position of the coin depositing port 421 in parallel with the coin discharge dish 422.

The bill depositing port 411 receives bills to be deposited to the bill change machine 41. The bill discharge port 412 dispenses bills from the bill change machine 41. A position-relationship between the bill depositing port 411 and the bill discharge port 412 depends on the structure of the bill change machine 41. Further, the bill depositing port 411 and the bill discharge port 412 are separated (shifted) along the width direction of the first housing 11 with respect to the coin discharge dish 422.

In addition, LEDs (Light Emitting Diode) 43, 44, 45 and 46 for informing an operation procedure or an error state are arranged respectively in the vicinity of the coin depositing port 421, the coin discharge dish 422, the reject dish 423, the bill depositing port 411 and the bill discharge port 412. Positions at which the LEDs 43˜46 are arranged are not limited in particular as long as they are located in the vicinity of each section. Further, the number and the arrangement of the LEDs 43˜46 are not limited in particular.

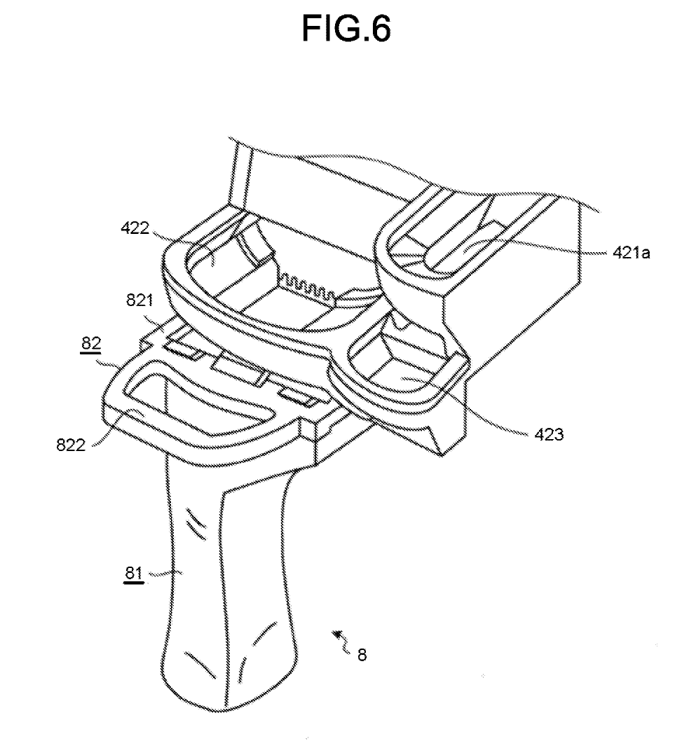

As shown in FIG. 4 and FIG. 5, the self-checkout register 100 is provided with a collection bag 8. FIG. 6 is a perspective view illustrating the appearance of the collection bag 8. A symbol 421a in FIG. 6 denotes a destination (money depositing port of the coin change machine 42) to which a coin deposited from the coin depositing port 421 of the first housing 11 is guided.

The collection bag 8 is a container for receiving coins to be collected from the coin change machine 42, or coins to be retracted or saved at the time of overflow. The collection of the coins is carried out, for example, at the time the business is closed. The overflow is a case in which a storage amount of the coin change machine 42 exceeds a predetermined reference value.

The collection bag 8 is detachably mounted below the coin discharge dish 422. The coin change machine 42 includes a route for guiding a coin onto the coin discharge dish 422 and a route for guiding a coin to the collection bag 8 below the coin discharge dish 422, and switches a route for discharging a coin to either of the two routes accordingly.

The bill change machine 41 is arranged at a position shifted with respect to the coin change machine 42 in the width direction such that a space is left at a position, i.e., a below the coin discharge dish 422, adjacent to the bill change machine 41 (the space occupied by the collection bag 8 in FIG. 5). The collection bag 8 is formed in a shape suitable to this space.

The collection bag 8 includes a bag part 81 and a frame 82 (shown in FIGS. 5 and 6). The frame 82 includes a frame section 821 and a holding section 822. An opening of the bag part 81 is attached to the frame section 821, and in this way, the frame section 821 supports the bag part 81. The holding section 822 is formed at the front side of the frame section 821, and is used as a handle at the time of detaching the collection bag 8. In FIG. 6, in order to expose the frame section 821, the collection bag 8 slightly pulled out to the front side.

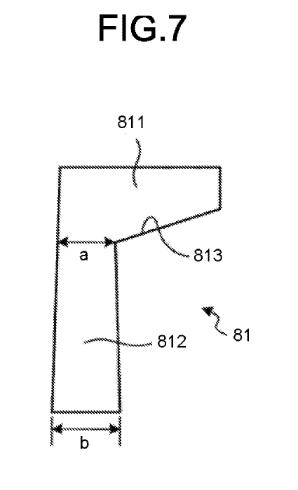

FIG. 7 is a front view illustrating a shape of the bag part 81 in a state in which the bag part is simplified. The bag part 81 is formed in a different shape in a vertical direction. The bag part 81 has a different width from the upper part to the lower part such that a first width “a” of the upper part is different from that a second width “b” of the lower part. The bag part 81 has a shape which does not interfere with the bill depositing port 411 and the bill discharge port 412 (shown in FIG. 5).

The bag part 81 is described step by step as an upper bag part 811, a lower bag part 812 and an inclined surface 813, respectively. The lower bag part 812 constitutes a hanging section for filling in the space adjacent to the bill change machine 41. The upper bag part 811 and the inclined surface 813 constitute a guide section for guiding a coin from the coin discharge dish 422 to the hanging section (lower bag part 812).

The upper bag part 811 is located at a space between the coin change machine 42 and the bill change machine 41, and has the same width and length as the coin discharge dish 422. The upper bag part 811 is located at the side but not on the bill depositing port 411 and the bill discharge port 412. The lower bag part 812 has a width fitted in the space left at the side of the bill change machine 41 in the first housing 11. The width “b” of the lower bag part 812 is larger towards the lower end side. In other words, a size indicated by “b” is larger than that indicated by “a” in FIG. 7.

The lower bag part 812 is connected with one of the sides of the upper bag part 811. The inclined surface 813 descends towards the lower bag part 812 and is arranged between the other side of the upper bag part 811 and the upper end of the lower bag part 812. The inclined surface 813 gradually narrows the width of the upper bag part 811, and further guides the coin entering the upper bag part 811 to the lower bag part 812.

The coin change machine 42 including the collection bag 8 stated above discharges coin to the coin discharge dish 422 or the collection bag 8. Whether the guide destination of the coin is selected to the coin discharge dish 422 or the collection bag 8 depends on the storage amount availability (emptiness condition or space availability) of the coin change machine 42. If the storage amount of the coin change machine 42 is a full state or a state close to the full state (for example, a state in which the storage amount is greater than the predetermined number of coins (threshold value)), the coin change machine 42 discharges coins to the collection bag 8.

Next, the hardware constitution of the self-checkout register 100 is described. FIG. 8 is a block diagram illustrating the hardware constitution of the self-checkout register 100. The settlement terminal 1 is equipped with the control section 7, an I/O device control section 71 and a communication I/F (interface) 72.

The communication I/F 72 connects the settlement terminal 1 with the bagging shelf 3 to perform communication. The I/O device control section 71 connects the control section 7 with the bill change machine 41, the coin change machine 42, the LEDs 43˜46, the scanner 50, the printer 51, the card reader 52, the monitor 61 and the touch panel 62.

On the other hand, the bagging shelf 3 is equipped with an I/O device control section 31, a communication I/F (Interface) 32 and a weighing device 33. The weighing device 33 measures the weight of an article placed on the bagging shelf 3. The communication I/F 32 connects the bagging shelf 3 with the settlement terminal 1 to perform communication. The I/O device control section 31 connects the weighing device 33 with the control section 7 via the communication I/F 32 and the communication I/F 72. The weighing device 33 measures the weight of the article placed on the bagging shelf 3 for the purpose of unfair conduct prevention.

The control section 7 includes a CPU (Central Processing Unit), a ROM (Read Only Memory) and a RAM (Random Access Memory). The ROM stores various computer programs executed by the CPU and various data. The RAM temporarily stores data and a computer program at the time the CPU executes the computer program. The control section 7 collectively controls each section in such a manner that the CPU copies or loads a computer program read from the ROM to the RAM to execute the computer program.

In such a constitution, the self-checkout register 100 is used in a state wherein the collection bag 8 is attached to the coin change machine 42. The control section 7 controls the coin change machine 42 to save coins to the collection bag 8 if the coin change machine 42 becomes an overflow state.

In a case in which the coin change machine 42 discharges coin to the collection bag 8, the coin enters the bag part 81 of the collection bag 8. Since the upper bag part 811 has a wide opening, a coin discharge path for coin collection is wide and thus, the coin collection can be carried out quickly. Further, since the lower bag part 812 has a narrow and elongated path and the bag part 81 is formed in a constricted shape, the coins collected in the lower bag part 812 are effectively trapped. Furthermore, since the lower bag part 812 has a wide lower end (bottom), the stored coins become stable.

The collection bag 8 has a capacity capable of collecting all the coins stored by the coin change machine 42. In a case of saving coins to the collection bag 8 at the time of overflow, coins for change are left in the coin change machine 42, and thus the amount of coins transferred to the collection bag 8 is smaller than that collected at the time of the coin collection. Thus, according to the present embodiment, overflow is prevented and personnel to attend to an overflow are not required.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A money depositing/dispensing apparatus, comprising:
a coin depositing/dispensing device, configured to store coins acquired through a coin reception port, which includes a first path along which the stored coins are discharged through a coin dispensing port and a second path along which the stored coins travel to be saved;
a bill depositing/dispensing device, configured to store bills acquired through a bill reception port and discharge the stored bills through a bill dispensing port, which is arranged at the lower side of the coin depositing/dispensing device in a space formed at the lower part of the coin dispensing port; and
a container, configured to store coins traveling along the second path, which is detachably attached to the coin depositing/dispensing device in the space.

2. The money depositing/dispensing apparatus according to claim 1, further comprising:
a control section configured to control the coin depositing/dispensing device to save coins in the container when the number of coins stored in the coin depositing/dispensing device reaches a predetermined number thereof, wherein
the money depositing/dispensing device is used with the container attached thereto.

3. The money depositing/dispensing apparatus according to claim 2, wherein
the container includes a hanging section, and a guide section located at the upper part of the hanging section to guide coins traveling along the second path to the hanging section.

4. The money depositing/dispensing apparatus according to claim 3, wherein
the guide section includes an inclined surface descending towards the hanging section.

5. The money depositing/dispensing apparatus according to claim 4, wherein
the hanging section includes a lower end having a width that is greater than a width of parts of the hanging section other than the lower end.

6. The money depositing/dispensing apparatus according to claim 1, wherein
the container includes a hanging section, and a guide section located at the upper part of the hanging section to guide coins traveling along the second path to the hanging section.

7. The money depositing/dispensing apparatus according to claim 6, wherein
the hanging section includes a lower end having a width that is greater than a width of parts of the hanging section other than the lower end.

8. The money depositing/dispensing apparatus according to claim 7, further comprising:
a control section configured to control the coin depositing/dispensing device to save coins to the container when the number of coins stored in the coin depositing/dispensing device reaches a predetermined number thereof, wherein
the money depositing/dispensing device is used with the container attached thereto.

9. A money depositing/dispensing apparatus, comprising:
a coin depositing/dispensing device, configured to store coins acquired through a coin reception port, which includes a first path along which the stored coins travel to be discharged through a coin dispensing port and a second path along which the stored coins travel to be saved;
a bill depositing/dispensing device, configured to store bills acquired through a bill reception port and discharge the stored bills through a bill dispensing port, which is arranged at the lower side of the coin depositing/dispensing device in a space formed at the lower part of the coin dispensing port;
a container, configured to store coins traveling along the second path, which is detachably attached in the coin depositing/dispensing device in the space; and
a control section configured to control the coin depositing/dispensing device to save coins to the container when the number of coins stored in the coin depositing/dispensing device reaches a predetermined number thereof.

10. The money depositing/dispensing apparatus according to claim 9, wherein
the money depositing/dispensing device is used with the container attached thereto.

11. The money depositing/dispensing apparatus according to claim 10, wherein
the container includes a hanging section, and a guide section located at the upper part of the hanging section to guide coins traveling along the second path to the hanging section.

12. The money depositing/dispensing apparatus according to claim 11, wherein
the guide section includes an inclined surface descending towards the hanging section.

13. The money depositing/dispensing apparatus according to claim 12, wherein
the hanging section includes a lower end having a width that is greater than a width of parts of the hanging section other than the lower end.

14. The money depositing/dispensing apparatus according to claim 9, wherein
the container includes a hanging section, and a guide section located at the upper part of the hanging section to guide coins traveling along the second path to the hanging section.

15. The money depositing/dispensing apparatus according to claim 14, wherein
the hanging section includes a lower end having a width that is greater than a width of parts of the hanging section other than the lower end.

16. A self-checkout apparatus, comprising:
a basket placing shelf;
a bagging shelf; and
a coin depositing/dispensing device, the coin depositing/dispensing device configured to store coins acquired through a coin reception port, which includes a first path along which the stored coins travel to be discharged through a coin dispensing port and a second path along which the stored coins travel to be saved;
a bill depositing/dispensing device, configured to store bills acquired through a bill reception port and discharge the stored bills through a bill dispensing port, which is arranged at the lower side of the coin depositing/dispensing device in a space formed at the lower part of the coin dispensing port; and
a container, configured to store coins traveling along the second path, which is detachably attached in the coin depositing/dispensing device in the space.

17. The self-checkout apparatus according to claim 16, wherein the money depositing/dispensing apparatus further comprises:
a control section configured to control the coin depositing/dispensing device to save coins to the container when the number of coins stored in the coin depositing/dispensing device reaches a predetermined number thereof, wherein
the money depositing/dispensing device is used with the container attached thereto.

18. The self-checkout apparatus according to claim 17, wherein
the container includes a hanging section, and a guide section located at the upper part of the hanging section to guide coins traveling along the second path to the hanging section.

19. The self-checkout apparatus according to claim 18, wherein
the guide section includes an inclined surface descending towards the hanging section.

20. The self-checkout apparatus according to claim 16, wherein
the container includes a hanging section, and a guide section located at the upper part of the hanging section to guide coins traveling along the second path to the hanging section; and
the hanging section includes a lower end having a width that is greater than a width of parts of the hanging section other than the lower end.
